(19) United States
(12) Patent Application Publication
(10) Pub. No.: US 2010/0228592 A1
(43) Pub. Date: Sep. 9, 2010

(54) ENTERTAINMENT SYSTEM FOR PROVIDING PERSONALIZED ADVERTISEMENTS

(75) Inventors: Andrew T. Anderson, Los Gatos, CA (US); Charles Gilbert, San Jose, CA (US); Vinod Viswanathan, Cupertino, CA (US); Wiliam Luciw, Palo Alto, CA (US); Madhusudan Therani, San Jose, CA (US)

Correspondence Address: CARR & FERRELL LLP, 2200 GENG ROAD, PALO ALTO, CA, 94303, US

(73) Assignee: ZillionTV Corporation, Sunnyvale, CA (US)

(21) Appl. No.: 12/397,007

(22) Filed: Mar. 3, 2009

(51) Int. Cl. G06Q 30/00; G06Q 99/00

(52) U.S. Cl. 705/10; 705/14.49

(57) ABSTRACT

Media is provided to a client device in response to a request with dynamically selected advertisements. One or more advertisements can be dynamically selected by an application server based on user data, advertisement parameters and other data to provide in or near the requested media. Attributes can be determined for one or more advertisement sets in which advertisements are placed within the requested media. The advertisement sets may be configured with the identified advertisements by an application server, and the requested media content and identified ads can be provided to the requesting client device.

### CROSS REFERENCE TO RELATED APPLICATIONS

This application is related to U.S. nonprovisional patent application Ser. No. ______, titled “REAL TIME AD SELECTION FOR REQUESTED CONTENT” and filed on Mar. 3, 2009, the disclosure of which is incorporated herein by reference.

### BACKGROUND

Traditional media content providers such as television broadcasters and internet networks provide content on behalf of an artist, author, or production house. In some systems, an intermediary acquires content from the content provider and often negotiates with an intermediary broadcaster or network provider who then negotiates with resellers and advertisers based on content provided by the network or system. Acquired content and associated advertising is typically pushed to a group of users via channels controlled by the intermediary or network service provider. The advertising is typically chosen to match the content, content popularity, and/or user groups thought to view such content. This is commonly known as the push model.

Some systems allow a user to choose specific items of content. For example, internet-based services allow a user to choose a desired song to be downloaded from the internet and/or order a desired movie or TV show for viewing. Such systems typically require the a priori knowledge of which item of content is desired. For example, a user may wish to choose from among thousands of movies, thousands of TV shows, hundreds of thousands of songs, millions of web pages, or other large numbers of media items. This is commonly known as the pull model.

Existing systems that push media content provide a limited system for delivering content to a user in an efficient and cost-effective manner, do not provide the advertiser with a cost effective manner, or a manner by which the advertiser can verify with certainty, that a user, or group of users has actually viewed the ad, nor can the advertiser target specific users, or user groups, based on a set of parameters, or allow the users to determine themselves which advertisements they want to view, and as a result cost the user, advertisers and entertainment service partners time and money.

### SUMMARY

The technology described herein pertains to an interactive media based entertainment service that provides user requested media and products to a user and in addition may recommend non-user requested interactive media and offers that match user preferences and viewing usage behavior patterns. Video, audio, images and other media may be provided to a user for a fee or free of charge, or any combination of both. The media may be provided from the service provider to a client device over a network. When providing media without charge, the entertainment service can incorporate one or more ads into, surrounding or near the media. The ads may be targeted to the user, media content, and other features using advertisement parameters.

Advertisements are provided to a user based on a combination of user preference and other user information as well as advertising parameters. Ads can be inserted into requested video content or in an ad on demand service. The ad may be inserted into the video content as part of one or more ad sets. An ad set, or a commercial break, contains one or more ads. The ad sets can be configured for a particular piece of video content with attributes such as number of ad sets, length and position within the content, and other attributes which are determined dynamically. Ads may also be viewed through an ad on demand user interface. The ad on demand user interface can provide previously played ads as well as ads selected for a user.

An embodiment for providing media to a client may begin with receiving a request for media content. The content request can be received from a client device by an application server. One or more advertisements can be selected by the application server to provide in the requested media. The application server may also determine attributes for one or more advertisement sets to place in or near (adjacent to) the requested media. The advertisement sets may be configured with the identified advertisements by the application server, and the requested media content and identified ads can be provided to the requesting client device. The ad on demand user interface can also recommend unwatched ads that are related to preferences or user behavior.

An embodiment for providing media to the client may start with receiving a request for media content. The request can be received from a client device by an application server. A first set of advertisements can be identified by the application server from a first group of advertisements that satisfy a user preference. A second set of advertisements can be selected from the first group of advertisements that satisfy a parameters associated with the advertisements. A third advertisement set can then be identified which contains advertisements in both the first set and second set of advertisements. Ads can then be inserted from the third set of advertisements in the selected insertion points of the requested media by the application server. The requested media content and inserted ads is then provided by the application server to the client device.

### BRIEF DESCRIPTION OF THE DRAWINGS

FIG. 1 is a block diagram of an exemplary system for providing an entertainment service to a user.

FIG. 2 is a flow chat of an exemplary method for providing content to a user.

FIG. 3 is a flow chart of an exemplary method for providing video content.

FIG. 4 is a flow chart of an exemplary method for identifying ads to place in requested video content.

FIG. 5 is a block diagram illustrating the intersection of two sets of ads.

FIG. 6 is a flow chart of an exemplary method for determining ad set attributes.

FIG. 7 is a flow chart of an exemplary method for configuring ad sets with identified ads.

FIG. 8 is a flow chart of an exemplary method for playing requested content with configured ad sets.

FIG. 9 is a flow chart of an exemplary method for providing requested advertisement content.

FIG. 10 is a flow chart of an exemplary method for identifying and displaying ads within a user interface.

FIG. 11 is a block diagram of an exemplary computing device.

### DETAILED DESCRIPTION

The technology described herein pertains to an interactive media based entertainment service that provides user requested media and products to a user and in addition may recommend non-user requested interactive media and offers that match user preferences and viewing usage behavior patterns. Video, audio, images and other media may be provided to a user for a fee or free of charge, or any combination of both. The media may be provided from the service provider to a client device over a network. When providing media without charge, the entertainment service can incorporate one or more ads into, surrounding or near the media. The ads may be targeted to the user, media content, and other features using advertisement parameters, user preferences and behavior.

Advertisements are provided to a user based on a combination of user preferences, demographic data, geographic location, behavior data, and other user data, advertisement parameters, content meta-data, temporal data, and other data. Ads can be inserted into or near requested video content or in an ad on demand service. The ad may be inserted into or near the video content as part of one or more advertisement sets or “pods.” An ad set can contains one or more ads. The ad sets can be configured for a particular piece of video content with attributes such as number of ad sets, length and position within the content, and other attributes which are determined dynamically. Ads may also be viewed through an ad on demand user interface. The ad on demand user interface can provide previously played ads as well as ads selected for a user. Ads may be traditional television commercials or interative multimedia commercials including surveys, polls, informerrcials or other forms of media based advertisements' for related products or services.

Examples may be referred to herein related to receiving a request for video content, providing selected advertisements in the requested video, and providing the requested video and selected advertisements to a requesting client. These media specific discussions are intended as examples only. The technology and systems discussed here are intended to work with different types of media, including audio, animation, images, and other media, and any specific reference to video or any other media is strictly for purposes of example.

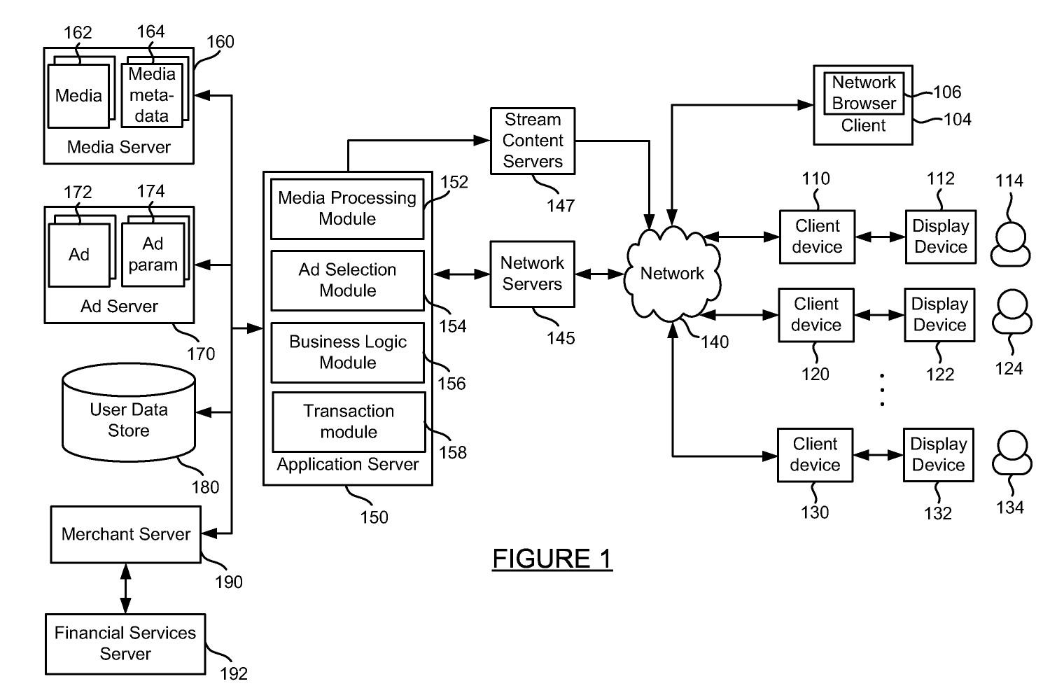

FIG. 1 is a block diagram of an exemplary system for providing an entertainment service to a user. The system of FIG. 1 includes a system of servers in communication with a system of client devices over a network. Client devices 110, 120 and 130 communicate with display devices 112, 122 and 132, respectively. Users 114, 124 and 134 are associated with each display device and client device combination, respectively. For example, a user 114 may provide input to client device 110 to retrieve and playback video content through display device 112. In some embodiments, the media service discussed herein is implemented by application server 150 and network server 145. In some embodiments, the system providing media service can also include any of servers 160-190.

Client 104 is coupled to network 140 and may include network browser 106. Network browser 106 may request, receive and provide network content such as a web page. For example, a user may access a media service provided over network 140 through network browser application 106.

Client devices 110-130 and client 104 are coupled to network 140. In some embodiments, each of client devices 110-130 may be implemented as a set-top box or other media device which provides content through a viewer user interface. An exemplary set-top box is disclosed in U.S. patent application Ser. No. 12/360,007, entitled “Set-Top Box,” filed on Jan. 26, 2009, the disclosure of which is incorporated herein by reference. Other devices may embed the technology directly, including but not limited to television sets, mobile devices, gaming consoles, watches, phones, and digital cameras.

Network 140 can facilitate communication between network server 145, client 104 and client devices 110-130. Network 140 may be implemented as the Internet or other WAN, a LAN, intranet, extranet, private network or a combination of networks.

Network server 145 can include one or more servers and communicates with application server 150 and network 140. Network server 145 can be implemented as a web server that operates as an intermediary server between application server 150 and network 140. For example, network server 145 may be a web server or application web server that receives requests from client devices 104, 110, 120 and 130, processes and forwards the requests to application server 150, and sends a response generated by application server 150 to the requesting client device.

Application server 150 communicates with network server 145, can include one or more servers, and includes logic which implements the media service of the present technology. Application server 150 can include media processing module 152, ad selection module 154, business logic module 156 and transaction module 158. Each of the modules 152-158 can be implemented on a different application server or backend server, such as servers 160-190. Other modules and logic may be incorporated on application server in addition to those illustrated in FIG. 1.

Media processing module 152 may receive, encode, and transmit video, audio, images and other media to client devices 104 and 110-130 through network server 145. The media may be transmitted as a complete file, a streaming data such as streaming video, or in some other format. Media processing module 152 may incorporate selected advertisements received from or identified by ad selection module 154 within video media and transmit the video media with the incorporated ads.

Ad selection module 154 may access advertisement media and advertisement parameters from ad server 170. The ad parameters specify how ads can be incorporated into a particular media file by media processing module 152. The parameters can indicate a user gender, geographic location, income level, marriage status, or other user demographic data, as well as user viewing behavior, purchase behavior, and other user data, or the ad may be selected directly by the user. The ad parameters may also specify content categories, brand adjacency, frequency requirements, cost information, and other display rules for providing the ad to a user.

Business logic module 156 may handle various business logic and processing rules associated with the media service. For example, business logic module 156 may handle user loyalty and reward programs which reward a user for certain viewing behavior and interaction with advertisements. Business logic module 156 may also retrieve and manage user data contained in user data store 180 and determine revenue distribution among different participants in a media service ecosystem, such as users, advertisers, content providers, merchants, network service provider companies (cable companies, power companies, telephone companies, and so forth), and other groups.

Transaction module 158 may facilitate commerce transactions between a client device and merchant server 190. Facilitating a purchase transaction allows a user to purchase goods or service associated with an advertisement through the media service.

Application server 150 may transmit content through stream content servers 147. In some embodiments, stream content servers 147 may include one or more servers configured to stream content to several client devices. For example, stream content servers 147 may include a host stream device which receives media and advertising content. The host stream device may provide content to one or more streaming servers which establish connections with a client device and stream media content, including requested and recommended media as well as advertisements, to the client.

Application server 150 may communicate with media server 160, ad server 170, user data store 180, and merchant server 190. Media server 160 may store media 162 and related information, including metadata 164 for stored media, which may be retrieved by application server 150. Media 162 may comprise movies, TV episodes, offers, and other video, as well as audio and image media, interactive media and application services such as two-way Voice Over Internet Protocol (VOIP) telephony, two-way video and other interactive applications. Media metadata 164 may include information associated with each piece of media or an offer, such as a media category (i.e., sports, documentary, family, and so forth), media length, potential breaks within the media for inserting ads, cost of playback for media, and other data associated with the media.

Ad server 170 can communicate with application server 150 and may include one or more advertisements 172 as well as advertisement parameters 174 associated with each ad. Advertisements 172 may be associated with a company, product, service or some other topic of potential interest for a user. The ad parameters indicate to whom a particular ad should or is required to be provided to, as well as cost information, timing information and other ad requirements. Ad parameters may be configured for an advertisement by an advertiser with preferred and required parameters for matching an ad to a combination of a user data (including user demographic data), media content, and time.

User data store 180 can communicate with application server 150 and data for users having an account with the media service. User information may include, for each of one or more users, user demographic information, user behavior information, user content preferences, and other user information. Use demographic information may include information that a user provides to the service, such as a user's gender, marital status, income, ethnic background, and other data. User behavior information may include information associated with past user behavior observed by the entertainment service. User content preferences may include one or more categories of media content that a user has indicated are preferable to the user. Examples of preferred content categories may include news, sports, movies, television shows, one or more types of genres, and other information. Examples of user behavior may include history of interaction with programs, content, commercials, navigation within the television service, repeat visits, dwell times, responses to polls, surveys, interactive media, infomercials, and product offers or requests for more information.

Merchant server 190 handles purchases requested by a user through client device 130. Merchant server 190 may be associated with an e-commerce service, a particular service or product provider, or some other organization. Merchant server 190 may communicate with one or more banks or credit card, credit card processing services, merchant gift cards, pre-paid merchant cards, or other financial services as represented by financial server 192.

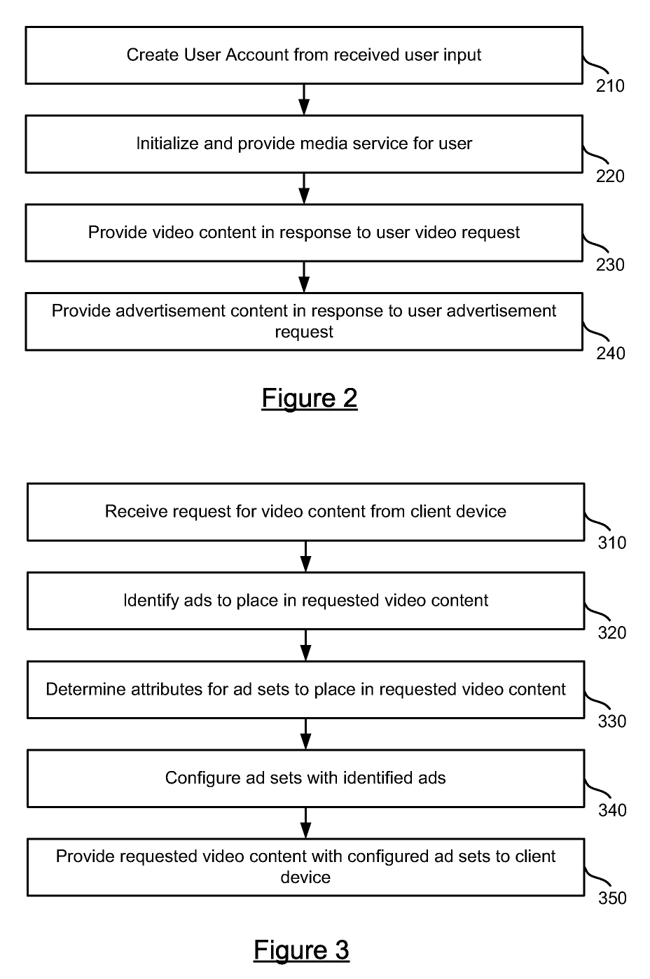

FIG. 2 is a flow chart of an exemplary method for providing content to a user. A user account is created from received user input at step 210. Application server 150 can create a user account from user data received from any of client device 104 or client device s 110-130 over network 140. For example, a user may create an account through a web portal provide by application server 150 and network servers 145 through web browser 106 (for example, “Internet Explorer” by Microsoft Corporation, of Redmond, Wash.) on client device 104. The user data may include demographic information, user preferences, and other user data. User data received may be stored for the user at user data store 180 by application server 150.

After creating a user account, the entertainment service is initialized for the user at step 220. Initialization may include establishing a connection with a client device 110, for example a client device which comprises a set top box, by application server 150 or network server 145 over network 140. The initialization may include registering the client device with an account, collecting connection and location information for the client device, and other tasks.

Video and interactive multimedia content can be provided in response to a user video request at step 230. A request for video or other media may be received by application server 150 from client device 110. A user may initiate the request by navigating a user interface provided by client device 110. While navigating the user interface, the user may browse media content information, products or search information, search for specific or suggested media, and provide a selection for media. Client device 110 can transmit the request for the video content to application server 150 over network 140 and network servers 145. The request may be received and processed by application server 150, and the requested content can be provided to client device 110 by application server 150 in response to the request. In some embodiments, one or more selected advertisements can be dynamically selected and inserted into the selected video content provided to the user. Client device 110 may receive and playback the requested content, including the requested media and one or more selected advertisements. Providing video content in response to a user video request is discussed in more detail below with respect to FIG. 3.

As media is provided to a user, user behavior in playing the media can be logged and transmitted to application server 150. For example, user behavior such as fast forwarding, pausing, rewinding, performing slow motion or jump to key frame actions, and other user actions during playback can be recorded and/or stored. The user behavior data is stored by application server 150 to user data store 180 and can be retrieved when selecting subsequent ads to provide to the user. Monitoring, logging and management of user behavior data is further described in in U.S. patent application Ser. No. 12/390,308, entitled “Media Based Entertainment Service,” filed on Feb. 20, 2009, the disclosure of which is incorporated herein by reference

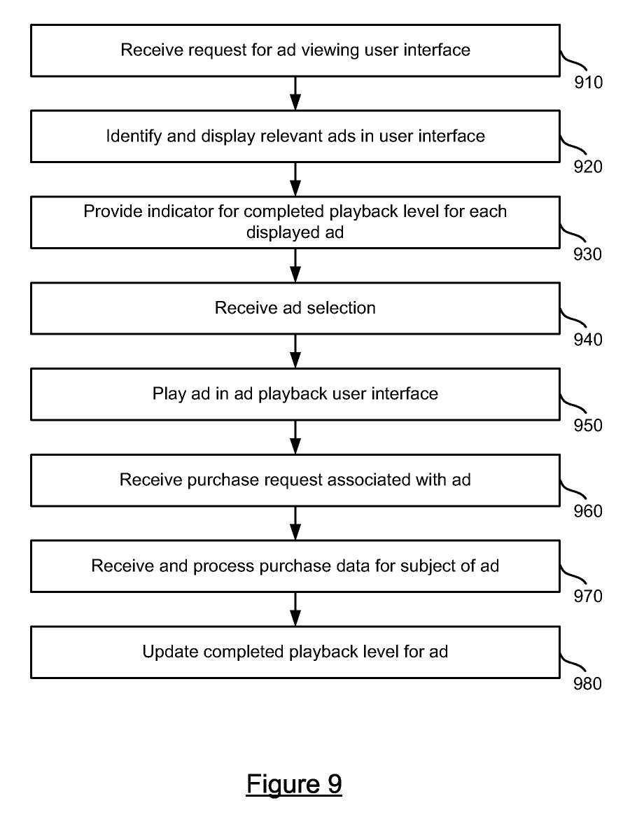

Advertisement content can be provided to a user in response to a user advertisement request at step 240. A user may navigate an entertainment service interface which identifies ads for playback. Thus, a user may navigate an interface which provides information for advertisements which a user may select and playback through client device 110. The ads provided in the interface can be selected by the entertainment service based on user preferences, demographic and behavior data as well as advertiser parameters for the ads. Providing advertisement content in response to a user advertisement request is discussed in more detail below with respect to FIG. 9.

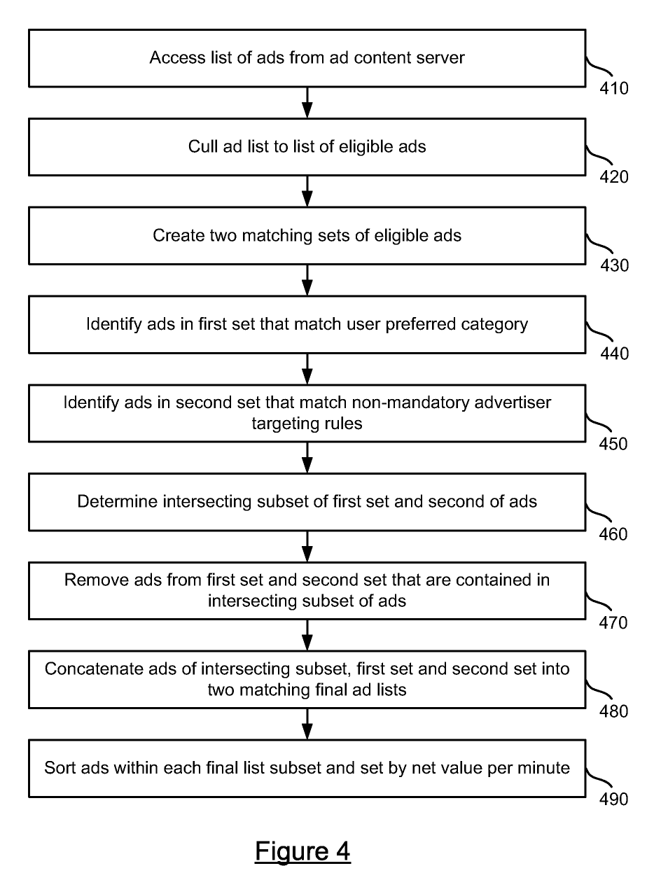

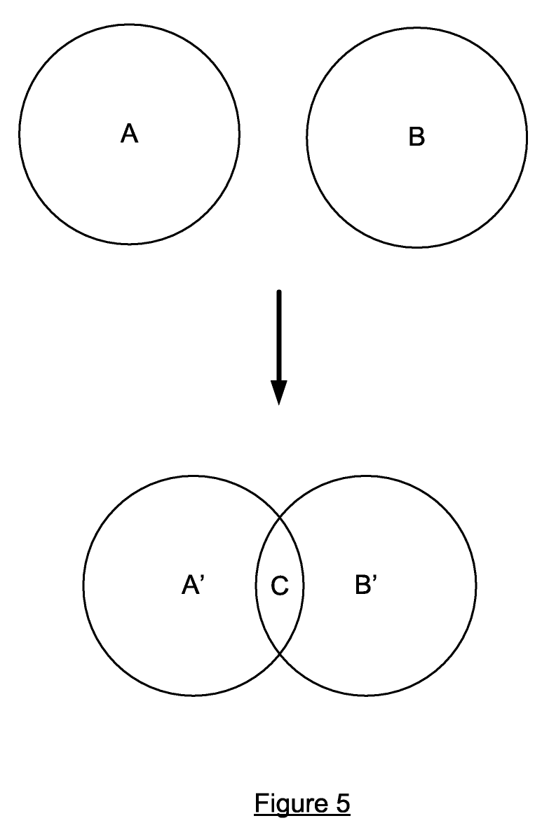

FIG. 3 is a flow chart of an exemplary method for providing video content to a client device. The method of FIG. 3 provides more detail for step 230 of the method of FIG. 2. Though the method of FIG. 3 is discussed with respect to a request for video media, the method may be applied to any type of media request. First, a request for video content can be received from client device 110 at step 310. In some embodiments, the request is received by application server 150 via network 140 and network servers 145. Ads can be identified to place in the requested video content at step 320. The ads can be selected based on user preferences, demographic data, behavior data and other user data, as well as advertiser parameters, the content selected, the time at which the content is to be played, and other data. In some embodiments, requested content can be “sponsored” by an advertiser. Sponsored content may be provided without ads inserted into the body of the content and step 320 need not be performed. In some embodiments, alternative types of sponsorship do not replace step 320 but instead influence what is performed at step 320. For example, one type of sponsorship may be enable media content to be provided with limited commercial interruption. Identifying advertisements to provide in video (or other media) requested by a client device is discussed in more detail below with respect to FIG. 4.

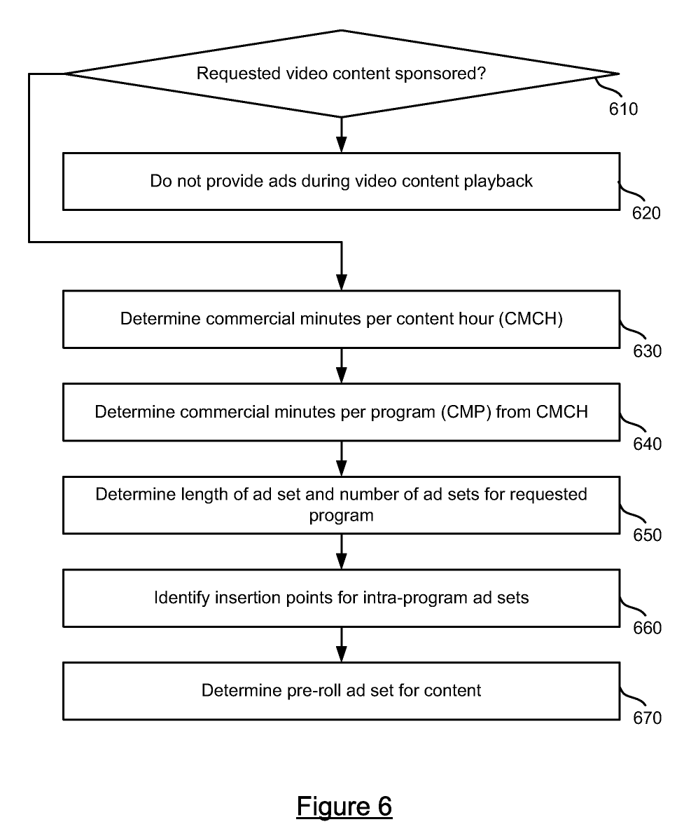

Attributes for ad sets to place within or near a requested video may be determined at step 330. The attributes can specify features of an ad set or “pod” to insert in the media content, wherein example features include the number of ad sets, the ad set length, the insertion points within the video content, and other data. Determining attributes for ad sets to place in the requested video content is discussed in more detail below with respect to FIG. 6.

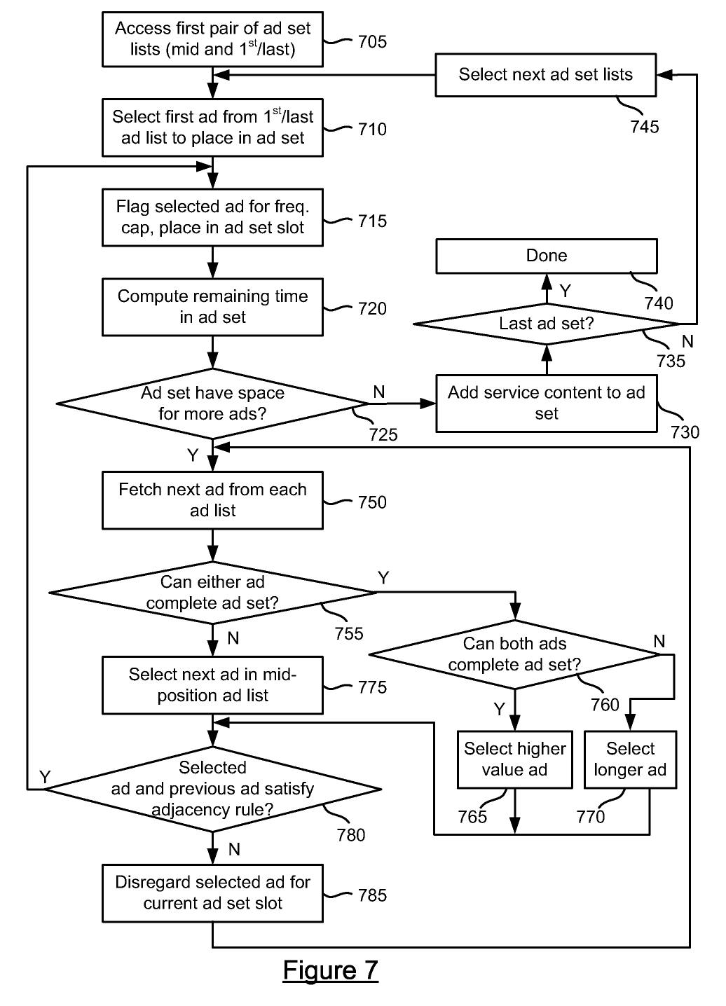

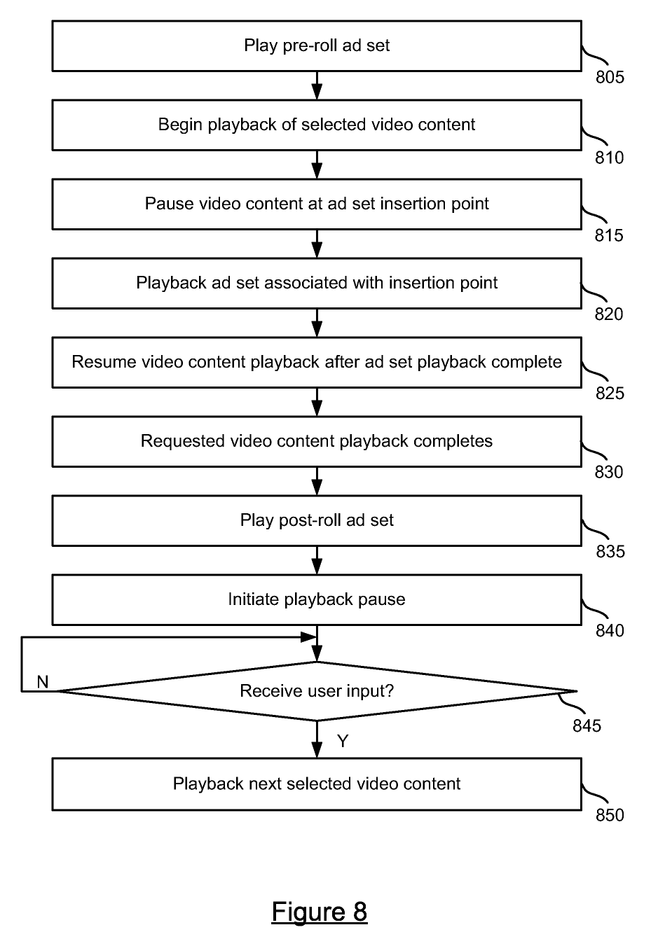

The ad sets are configured, or populated, with the identified ads at step 340. Put another way, the ad sets identified in step 330 are filled with ads identified in step 320. The ads are dynamically chosen such that they are correspond to user data as well as advertiser parameters. Configuring ad sets with identified ads is discussed in more detail below with respect to FIG. 7. After configuring the ad sets with identified ads, the requested media content with the configured ad sets is provided to client device 110 by application server 150 at step 350. The requested media content and system selected advertisements can be provided via a media stream by stream content server 147, a single file download by application server 150 or servers 147, or some other method to client device 110. Providing requested media to a client device is discussed in more detail below with respect to the method of FIG. 8.

FIG. 4 is a flow chart of an exemplary method for identifying ads to place in or near requested video content. In some embodiments, the method of FIG. 4 provides more detail for step 320 and can be performed by the ad selection module 154 of application server 150.

A list of ads is accessed from advertisement server 170 at step 410. The accessed list of ads can include all ads provided by advertisers via one or more advertisement severs 170 and available to application server 150. The ad list is then culled or reduced to a list of eligible ads at step 420. The list of all available ads may be culled by removing ads that have expired, are over budget, or are otherwise disabled. For example, expired ads were configured to be played during a specified window of time which has expired. Over budget ads are associated with a payment scheme, such as a trust, which is depleted and to play the ad further would result in the payment scheme going over budget. Ads that may be otherwise disabled may be in the system but are not to be displayed until a future time.

Ads may also be removed from the accessed list of available ads by applying mandatory advertiser parameters to the ads. For example, advertiser parameters may indicate that a particular ad should not be played to a user who does not have any children, has a particular income level, or some other rule or preference provided by an advertiser related to a user characteristic, content characteristic, time of day or other feature. Ads may also be removed from the list if they are associated with adult content or have a TV rating, Motion Picture Association, or Advertisement rating which is not satisfied by the age of the user currently requesting the corresponding content.

Advertiser targeting parameters can be mandatory or optional. This differs from traditional advertising parameters regarded as inviolate.

Two matching sets of eligible ads are created at step 430. The two matching sets are initially created as matching copies of the resulting list of eligible ads identified at step 420. At step 440, ads are selected to be included in the first set if they match a user preferred category for the user requesting the content with which the ads will be included. For example, if a user has identified categories of news, sports or cars, any ads tagged with a category of one of these areas are identified to include in the first set. User category data of user categories may be retrieved by application server 150 from user data store 180. Ads that do not satisfy a user preference are removed from the first set of ads by ad selection module 154.

Ads are selected to remain in the second set if they or the user satisfies non-mandatory advertiser parameters at step 450. Thus, advertiser parameters which are not mandatory but are preferred by the advertisers are used to identify a subset of the ads within the second set of eligible ads. For example, an advertiser may have non-mandatory parameters which indicate a preferred age, gender, location or other data associated with a user, content to show, or a time the content will be played. Ads that do not satisfy the non-mandatory advertiser parameters for the current user, content, time and other parameters are removed from the second set of ads by ad selection module 154.

An intersecting subset of the first set and second set of ads is determined at step 460. The intersecting subset will include a list of ads that are found in both the first set and the second set of advertisements identified in steps 540 and 550, respectively.

FIG. 5 illustrates a block diagram illustrating the selection and intersection of selected ads discussed with respect to the method of FIG. 4. In the diagram, the first set of ads which match a user preferred category is represented by the circle A. The second set of ads that matches non-mandatory advertiser parameters is indicated by the circle B. Portion C represents the intersection of portions A and B corresponding to step 460 of the method of FIG. 4.

Ads are removed from the first set and the second set that are contained in the intersecting subset of ads at step 470. With respect of FIG. 5, ads are removed from A to result in a set of ads A′ and ads are removed from B to result in a set of ads represented by B′. As a result, A′ plus C would equal to A, and B′ plus C is equal to B.

Application server 150 then concatenates ads of the intersecting subset, the first set associated with user preferences, and the second set associated with advertisement parameters into two identical final ad lists. The lists are comprised of ads in the order of the intersected ads, the first set of ads that match a user preferred category, and the second set of ads that match the non-mandatory advertiser parameters, wherein the first set and the second set do not include ads within the intersecting subsection.

The ads are then sorted in each final ad list by a net value per minute at step 490. Within each ad list, the ad selection engine of application server 150 will store the ads by a normalized net value. For example, the ad selection engine may sort the ads by a cost per 1000 ads per minute. In some embodiments, ads may have an increased value if played as the first ad in an ad set or the last ad in an ad set as compared to an ad in the middle of an ad set. For this reason, the two lists may include a first list sorted by advertisement value when each ad is placed as the first ad or the last ad in an ad set, as well as a second list which is sorted by ad value when the ad is assigned a mid slot position within an ad set.

In some embodiments, the ads sort criteria is a value that has been normalized with respect to time. The value can be scaled either up or down based on other factors. For example, an ad's present status with respect to being over served or underserved can be a factor in the ad sort. Thus, if there is a budget of $100,000 collected for serving a particular ad and at the time of serving, the system has only collected half that money. If at the time of serving, the system is already past the half way point between the start and end date for the particular ad, then the system may choose to inflate the sort position of that ad to encourage its being served over other ad that are temporarily more lucrative but that have more time to be fulfilled.

FIG. 6 is a flow chart of an embodiment of a method for determining ad set attributes. In some embodiments, the method of FIG. 6 provides more detail for step 330 of the method of FIG. 3. A determination is made at step 610 as to whether media content requested by client device 110 is sponsored. Content that is sponsored may not require ads be inserted into the content. For example, an action movie with one or more car chases might be sponsored by a car company. If requested video content is sponsored, then ads may not be provided during the video content playback as indicated at step 620. If requested video content is not sponsored, the advertisement minutes per content hour for the requested media content is determined at step 630. In some embodiments, the number of commercial minutes to insert for each hour of content of the requested content may be fixed, such as 14 minutes per content hour. In some embodiments, the commercial minutes per content hour may be based on the cost of the program, the value to the viewer, and the value to advertisement itself.

Broader applications of the multiple sort concept are within the scope of the present technology. The present system can maintain multiple sort lists and may dynamically decide which sort list is most appropriate based on many factors. The two sort lists discussed above cover the first in pod versus mid-pod cases are likely to be two sort list of many dozens.

The commercial minutes per program are determined from the commercial minutes per content hour at step 640. In some embodiments, commercial minutes per program may be determined as the length of the program in minutes divided by 60 and then multiplied by the commercial minutes per content hour determined at step 630.

A length of the ad set and the number of ad sets for requested content is determined for the requested content at step 650. In some embodiments, an ad set length may be fixed at some length plus or minus a period of time. For example, an ad set may be fixed at 2 minutes and 37 seconds plus or minus 23 seconds. A number of ad sets may also be determined based on the commercial minutes per program per length of content or as a fixed value, for example three ads per 20 minutes of content.

Insertion points for intra-program ad sets are identified at step 660. The insertion points may be identified manually or using digital processing techniques. Several insertion points may be identified for a particular program. Typically, the content insertion points used will include the first insertion point and a number of additional insertion points. In some embodiments, when the number of insertion points is not equal to the number of ad sets to be inserted, a series of rules may determine how many ad sets are included within the content. If the number of insertion points is greater than the number of ad sets, the first insertion point may be used and the remaining ad sets are spaced throughout the media content as equally as possible. In some embodiments, the desired insertion points may be selected based on the attributes of the individual insertion points. Such attributes could guide insertion of ads based on the ebb and flow of the drama. If the insertion points available are less than the total number of ad sets, then the number of ad sets used is the number of insertion points and at least one ad set is discarded.

Digital processing techniques for detecting insertion points are automated video processing tools that are used to determine ad insertion points based on analysis of the digital media content. For example, specific ad insertion cues may include: a) fade to blacks (or uniform colors), b) silence spots, c) scene changes (cuts)—defined by locational change, palette changes, introduction of new actors, d) changes in background levels, and so forth. Potential additional cues include a) changes in closed captioning text, b) face/on-screen object/on-screen text/on-screen product/logo recognition to trigger ad points or overlay advertisements, and c) detection of different types of relevant “scene change” features.

A pre-roll for the ad set may be determined for the requested video content at step 670. In some embodiments, a pre-roll may optionally be provided before playback of the requested video content. In some embodiments, a pre-roll may be replaced with a set of ads inserted prior to the beginning of the opening credits of the requested programming content. Thus, wherever a pre-roll is mentioned herein, it is intended that it could be replaced with set of ads inserted prior to the beginning of the opening credits of the requested programming content. For example, a pre-roll might only be provided for requested content if the content is a movie. In this example, if the requested content is not a movie, there will not be a pre-roll of advertisements provided before the movie.

FIG. 7 is a flow chart of an exemplary method for configuring ads sets with identified ads. Configuring the advertisement sets can include populating the ad sets with the selected advertisements. In some embodiments, the method of FIG. 7 provides more detail for step 340 of the method of FIG. 3.

A first ad set list is accessed at step 705. One pair of ad set lists can be created for each ad set to insert in or near a video content. Thus, if three ad sets are to be inserted into video content, there will be three pairs of set lists (six total ad lists) generated for inserting ads within the content. In embodiments where different sort criteria are used, more than two ad set lists can be generated for each ad. The pair of ad lists for each ad set consists of an ad list associated with different slots of the ad set. A first ad list of the ad list pair includes ads to be included in the first ad slot or last ad slot of an ad set. The second ad list of an ad list pair includes ads to include between the first and last ad slot. In some embodiments, the two ad lists are created to maximize value of ad placement when some ads may result in a higher payment to the entertainment service when placed first or last as opposed to between the first or last position within an ad slot.

A first ad to place in the current ad set is selected from the first ad list (the ad list of first slot and last slot ads) at step 710. The selected ad is flagged in the ad lists (for example, all six ad lists when there are three ad sets to fill) and placed in the current ad set slot at step 715. In some embodiments, the ad may be flagged or otherwise marked for non-use in all ad sets (not just the ad set list which it was recently selected from) until a condition is met. For example, the selected advertisement may have a frequency limitation indicating how often the advertisement can be provided to a user. For example, a particular ad may have a frequency limitation of 30 minutes, indicating that the ad may only be provided to a user every 30 minutes. When the frequency period associated with the selected ad expires, the advertisement can be unflagged in all ad sets and placed within an ad set slot.

In some embodiments, the present system can track what ads were viewed by a user and use the previous ad views to drive a specific predetermined set of ads to be displayed to a specific user in a specific pre-determined order.

In some embodiments, for each advertisement the system independently tracks the frequency of the advertisement's display and the time since most recent display for each user or viewer. For example suppose, the system can configures an ad with a maximum frequency cap of “4 times per day” and a minimum delay time of “5 hours.” If user views the ad, the system can ensure that the user will not see that ad more than 5 times over the next 24 hours and that no two viewings of that ad will occur for the particular user within any 5 hour period.

The remaining time for additional advertisements in the current ad set is computed at step 720. For example, an empty ad set may have a target length of 2 minutes and 20 seconds long. After adding a 20 second ad to an ad set, the ad set may have a remaining length of 2 minutes long.

A determination is made as to whether the ad set has space for more ads at step 725. In some embodiments, an ad set may be configured to have a length of 2 minutes and 20 seconds, with a variance of plus or minus 23 seconds. A typical advertisement may last 20-24 seconds. Thus, the ad set may have room if the last “slot” time still exists within the potential 2 minutes and 43 seconds of the ad set. If the ad set does not have space for more ads, then the current ad set is complete and ad service content is added to the ad set at step 730. The ad service content may be a short video or image identifying the content service and is added to the ad set.

If the current ad set is the last ad set to be added for the requested content at step 735, then the method of configuring ad sets is complete at step 740. If additional ad sets exist to be configured, the next ad set list corresponding to the next ad set are selected at step 745 and the method continues to step 710.

If an ad set has space for more ads, the next ad from each ad list is fetched at step 750. The fetched ad can be the ad at the top of each corresponding list. A determination is then made as to whether an ad from either ad list may complete the ad set at step 755. An ad may complete the ad set if addition of the ad brings the total length of the ad set to the ad set goal length minus the variance for the ad set. If either ad from each list may complete the ad set, a determination is made as to whether both ads may complete the ad set. If both ads can complete the ad set, the higher value ad is selected at step 765 and the method of FIG. 7 continues to step 780. If both ads cannot complete the ad set, then the longer ad is selected at step 770 and the method continues to step 780. If neither ad cannot complete the ad set at step 755, the next ad in the mid position ad list is selected at step 775 and the method of FIG. 7 continues to step 780.

A determination is made as to whether the selected ad and the previous ad within the ad set satisfy the adjacency rules for each ad at step 780. In some embodiments, an ad parameter may specify that an advertisement should follow another advertisement of the same product type, a competitor, or some other ad that satisfies an adjacency prevention rule. If they do satisfy the adjacency rules, then the method of FIG. 7 returns to step 715. If the ads do not satisfy the adjacency rules, then the selected ad is disregarded for the current ad slot at step 785 and the method of FIG. 7 returns to step 750. In some embodiments, the selected ad is disregarded by flagging the ad for one iteration of selecting an ad, so it will not be considered in the next iteration to determine which ad will follow the previous ad.

FIG. 8 is flow chart of an exemplary method for playing requested content with configured ad sets. In some embodiments, the method of FIG. 8 provides more detail for step 350 of the method of FIG. 3. First, a pre-roll ad set is played at step 805. A pre-roll is an ad set that is played before any of the requested video content is played. In some embodiments, a pre-roll set of advertisements is played for movie content request by a client device. In some embodiments, the first as set may be played after of short preview of the video content has been played. Playback of the selected video content then begins at step 810. Video content may then be paused at the ad set insertion point at step 815. The ad set insertion point is flagged by content engine within application server 150. An ad set associated with the insertion point is then played at step 820. Video content playback may then resume play after the ad set playback is complete at step 825. Requested video content then completes at step 830 and a post-roll ad set is played at step 835. In some embodiments, ad sets may be automatically inserted into or near the video content. A playback pause is initiated at step 840. The playback pause can be used to confirm that a user is actually viewing the content at the end of playback of the content. User input is received at step 845. By requiring user input, the system may confirm a user's presence and as well as, optionally, user activity during the post-roll ads. When user input is received, then the next selected video content is played back at step 850.

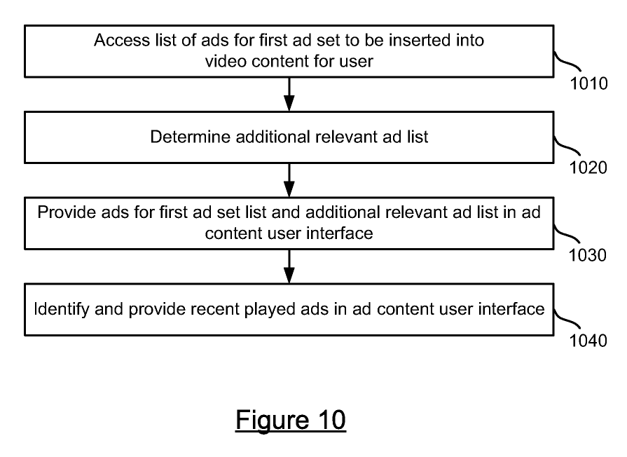

FIG. 9 is a flow chart of an exemplary method for providing requested advertisement content. In some embodiments, the method of FIG. 9 provides more detail for step 240 of the method of FIG. 2. First, a request for an advertisement user interface is received at step 910. The request may be received from a user who is navigating the entertainment service interface provided through client device 110. Next, relevant ads are identified and displayed in the user interface at step 920. The ad play list may be provided with the user interface as well as one or more sets of ads associated with the user and previously viewed by the user. Identifying and displaying relevant ads in a user interface is discussed in more detail below with respect to FIG. 10.

An indicator may be provided for a completed playback level for each displayed ad at step 930. The indicator can provide information regarding the level of playback achieved for the particular ad. For example, a green indicator may indicate that the ad was completely played back, a yellow indicator may indicate that an ad was played back up to 60% of the total ad time, and a red indicator may indicate that the ad was only played back up to 20% of the total time.

An ad selection is received at step 940 and the ad is played in the ad playback user interface at step 950. A purchase request may then be received at step 960. The purchase request may be received during playback of the ad and is associated with a product subject of the ad. The purchase request may be initiated by a user through remote control 105 while viewing the advertisement through display device 110. Purchase data may be received and processed through the subject of the ad at step 970. Receiving and processing purchase data may include collecting payment information, shipping data and other data and submitting the data to a payment service. The playback level for the ad is then updated at step 980. The ad playback data can be updated according to step 930 of the method of FIG. 9.

FIG. 10 is a flow chart of an exemplary method for identifying and displaying ads within a user interface. The method of FIG. 10 provides more detail for step 920 of the method of FIG. 9. First, a list of ads for a first ad set is accessed to be inserted into video content for the user. This list of ads for the first ad set is the “ad play list” generated at step 490 of the method of FIG. 4.

Additional relevant ad lists are then determined at step 1020. The additional relevant ad lists may match ads to categories of previously viewed ads as well as ads that target the user during the ads. The ads from the first ad set and additional relevant ad lists are then provided in an ad content user interface at step 1030. Additionally, previously played ads are then identified and provided in the ad content user interface at step 1040.

In addition to the above discussed technology, the present system may include tools that are provided to advertisers to manage their campaigns. For a campaign to be effective from an advertiser point of view, it has to be targeted at the correct audience and replayed a certain number of times to reinforce the message. In addition, certain advertisements can have time element to it, in that it expects people to react to the message within a specific time. Advertisements can be targeted at a regional level or at the national level.

The advertising system will provide to the advertiser necessary tools to identify target market and its size. Based on the our subscriber profiles, interests and preferences, our system can help advertisers identify markets for their products. This will allow the advertiser to define their campaign parameters including but not limited to geographical location, time, profile of the users and the content that must be targeted.

The system will also provide feedback to the advertisers in near real time on the performance of their campaign. Who watched it, where and in what context. The content is the content that carried the advertisement. This will allow the advertisers to adjust their campaign parameters based on the response. The system will make sure the new parameters are propagated through the system in near real time to enforce the changed set of constraints.

The system will be managing multiple campaigns, with different constraints which are dynamic. The inventory of the remaining number of views that needs to be served will be maintained by the system. The remaining views will also control the campaign is prioritized within the system.

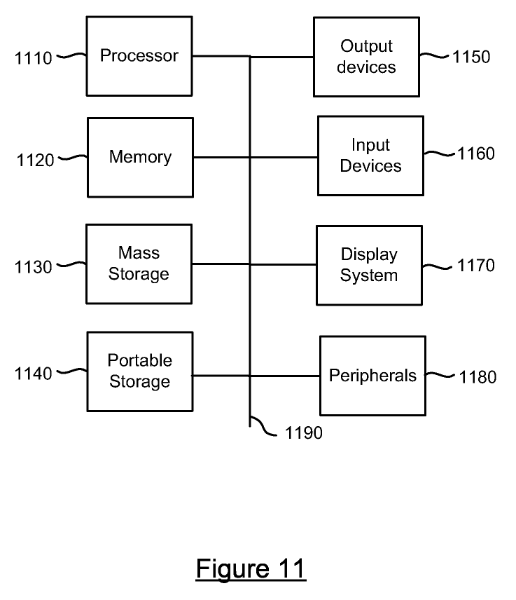

FIG. 11 is a block diagram of an exemplary computing device for implementing an interactive entertainment service environment. In some embodiments, the exemplary computing device of FIG. 11 may be used to implement client devices 104 and 110-130, network server 145, application server 150, media server 160, ad server 180, user data store 180, merchant server 190 and financial services server 192.

The computing system 1100 of FIG. 11 includes one or more processors 1110 and memory 1120. Main memory 1120 stores, in part, instructions and data for execution by processor 1110. Main memory 1120 can store the executable code when in operation. The system 1100 of FIG. 11 further includes a mass storage device 1130, portable storage medium drive(s) 1140, output devices 1150, user input devices 1160, a graphics display 1170, and peripheral devices 1180.

The components shown in FIG. 11 are depicted as being connected via a single bus 1190. However, the components may be connected through one or more data transport means. For example, processor unit 1110 and main memory 1120 may be connected via a local microprocessor bus, and the mass storage device 1130, peripheral device(s) 1180, portable storage device 1140, and display system 1170 may be connected via one or more input/output (I/O) buses.

Mass storage device 1130, which may be implemented with a magnetic disk drive or an optical disk drive, is a non-volatile storage device for storing data and instructions for use by processor unit 1110. Mass storage device 1130 can store the system software for implementing embodiments of the present invention for purposes of loading that software into main memory 1120.

Portable storage device 1140 operates in conjunction with a portable non-volatile storage medium, such as a floppy disk, compact disk or Digital video disc, to input and output data and code to and from the computer system 1100 of FIG. 11. The system software for implementing embodiments of the present invention may be stored on such a portable medium and input to the computer system 1100 via the portable storage device 1140.

Input devices 1160 provide a portion of a user interface. Input devices 1160 may include an alpha-numeric keypad, such as a keyboard, for inputting alpha-numeric and other information, or a pointing device, such as a mouse, a trackball, stylus, or cursor direction keys. Additionally, the system 1100 as shown in FIG. 11 includes output devices 1150. Examples of suitable output devices include speakers, printers, network interfaces, and monitors.

Display system 1170 may include a CRT, a liquid crystal display (LCD) or other suitable display device. Display system 1170 receives textual and graphical information, and processes the information for output to the display device.

Peripherals 1180 may include any type of computer support device to add additional functionality to the computer system. For example, peripheral device(s) 1180 may include a modem or a router.

The components contained in the computer system 1100 of FIG. 11 are those typically found in computer systems that may be suitable for use with embodiments of the present invention and are intended to represent a broad category of such computer components that are well known in the art. Thus, the computer system 1100 of FIG. 11 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A computer implemented method for providing media to a client device, comprising:
receiving a request for media content from a client device by an application server;
identifying one or more advertisements by the application server to provide in the requested media;
determining attributes by the application server for one or more advertisement sets to place in the requested media;
configuring the ad sets with the identified one or more advertisements by the application server; and
providing the requested media content with the configured ad sets to the client device.

2. The computer implemented method of claim 1, wherein identifying one or more advertisements includes selecting an advertisement based on a user preference.

3. The computer implemented method of claim 1, wherein identifying one or more advertisements includes selecting an advertisement based on previous user behavior.

4. The computer implemented method of claim 1, wherein identifying one or more advertisements includes selecting an advertisement based on previous user demographic data.

5. The computer implemented method of claim 1, wherein identifying one or more advertisements includes selecting an advertisement based on a parameter set by an entity associated with the advertisement.

6. The computer implemented method of claim 5, wherein the parameter identifies a user characteristic associated with a target viewer of the advertisement

7. The computer implemented method of claim 5, wherein the parameter identifies a requested media characteristic

8. The computer implemented method of claim 1, wherein determining attributes includes identifying the number of ad sets to include in the requested media content.

9. The computer implemented method of claim 1, wherein determining attributes includes identifying an insertion point for an ad set in the media content.

10. The computer implemented method of claim 1, wherein determining attributes includes identifying the length of an ad set.

11. The computer implemented method of claim 1, wherein configuring the ad sets includes selecting advertisements to include in the ad set based on a normalized advertisement value.

12. The computer implemented method of claim 1, wherein configuring the ad sets includes selecting advertisements to include in the ad set based on an advertisement adjacency rule.

13. A computer implemented method for providing media to a client device, comprising:
receiving a request for media content from a client device by an application server;
identifying a first set of advertisements by the application server from a first group of advertisements that satisfy a user preference;
identifying a second set of advertisements by the application server from the first group of advertisements that satisfy a parameters associated with the advertisements;
identifying a third set of advertisements by the application server that contain advertisements in both the first set and second set of advertisements;
inserting ads from the third set of advertisements in the selected insertion points of the requested media by the application server; and
providing the requested media content with the inserted ads by the application server to the client device.

14. The computer implemented method of claim 13, wherein the user preference is associated with a media category.

15. The computer implemented method of claim 13, further comprising inserting ads from the second sent and the third set of advertisements in the selected insertion points of the requested media, the order in which the ads are sorted being based on a configurable parameter.

16. The computer implemented method of claim 13, wherein the parameter is associated with a user characteristic or a media content characteristic.

17. The computer implemented method of claim 13, wherein inserting ads includes:
identifying a value for each advertisement in the third set of ads; and
inserting the highest value ads from the third set of ads into the requested media content.

18. A computer readable storage medium having embodied thereon a program, the program being executable by a processor to perform a method for providing media, the method comprising:
receiving a request for media content from a client device by an application server;
identifying one or more advertisements by the application server to provide in the requested media;
determining attributes by the application server for one or more advertisement sets to place in the requested media;
configuring the ad sets with the identified one or more advertisements by the application server; and
providing the requested media content with the configured ad sets to the client device.

19. The computer readable storage medium of claim 19, wherein identifying one or more advertisements includes selecting an advertisement based on a user preference.

20. The computer readable storage medium of claim 19, wherein identifying one or more advertisements includes selecting an advertisement based on previous user behavior.

21. The computer readable storage medium of claim 19, wherein identifying one or more advertisements includes selecting an advertisement based on a parameter set by an entity associated with the advertisement.

22. The computer readable storage medium of claim 21, wherein the parameter identifies a user characteristic associated with a target viewer of the advertisement

23. The computer readable storage medium of claim 21, wherein the parameter identifies a requested media characteristic

24. The computer readable storage medium of claim 19, wherein determining attributes includes identifying the number of ad sets to include in the requested media content.

25. The computer readable storage medium of claim 19, wherein configuring the ad sets includes selecting advertisements to include in the ad set based on a normalized advertisement value.

26. The computer readable storage medium of claim 19, wherein configuring the ad sets includes selecting advertisements to include in the ad set based on an advertisement adjacency rule.
